(19) United States
(12) Patent Application Publication
(10) Pub. No.: US 2006/0121934 A1
(43) Pub. Date: Jun. 8, 2006

(54) Mobile platform apparatus for multiple antenna system and apparatus for verifying mobile platform apparatus

(75) Inventors: Chan Bok Jeong, Daejeon-city (KR); Seung Chan Bang, Daejeon-city (KR); Soo Bum Kim, Daejeon-city (KR); Nam Il Kim, Daejeon-city (KR); Young Hoon Kim, Daejeon-city (KR); Sang Woo Nam, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/294,726

(22) Filed: Dec. 5, 2005

(30) Foreign Application Priority Data
Dec. 7, 2004 (KR) 10-2004-0102287
Oct. 21, 2005 (KR) 10-2005-0099598

(51) Int. Cl. H04M 1/00

(52) U.S. Cl. 455/550.1

(57) ABSTRACT

A mobile platform apparatus for a multiple antenna system and an apparatus for verifying the mobile platform apparatus are provided. The mobile platform apparatus includes: a baseband unit which receives transmission data to be transmitted to the external system, modulates the transmission data, receives baseband reception data, and demodulates the baseband reception data; an intermediate frequency (IF) unit which receives the modulated transmission data from the baseband unit, converts the modulated transmission data into IF transmission data, receives IF reception data, converts the IF reception data into the baseband reception data, and transmits the baseband reception data to the baseband unit; and a radio frequency (RF) unit which receives the IF transmission data from the IF unit, converts the IF transmission data into RF transmission data, transmits the RF transmission data to the external system, receives RF reception data from the external system, converts the RF reception data into the IF reception data, and transmits the IF reception data to the IF unit. Each of the IF unit and the RF unit comprises a plurality of paths, and the transmission data and the reception data are transmitted via at least one of the paths. Therefore, it is possible to provide a terminal function which can be executed either in real time mode or in non-real time mode in a multi-band multi-carrier environment for fourth generation wireless communication systems.

### CROSS-REFERENCE TO RELATED PATENT APPLICATION

This application claims the benefit of Korean Patent Application Nos. 10-2004-0102287 and 10-2005-009598, filed on Dec. 7, 2004 and Oct. 21, 2005, respectively, in the Korean Intellectual Property Office, the disclosures of which are incorporated herein in their entirety by reference.

### BACKGROUND OF THE INVENTION

1. Field of the Invention

The present invention relates to a mobile platform apparatus for a multiple antenna system and an apparatus for verifying a mobile platform apparatus, and more particularly, to a mobile platform apparatus for a multiple antenna system which can operate either in real time mode or in non-real time mode in a multi-band multi-carrier environment of a fourth generation (4G) wireless communication system and an apparatus for verifying the mobile platform apparatus.

2. Description of the Related Art

In recent years, research has been vigorously conducted on ways to enable 4G wireless communication systems to achieve high data transmission rates using a multiple input multiple output (MIMO) technique. However, mobile platform apparatuses for multiple antenna systems using a MIMO technique and apparatuses for verifying the mobile platform apparatuses have not yet been developed.

In addition, with an ever-growing demand for high data transmission rates over 100 Mbps (bit/sec) for 4G wireless communication systems, more public attention has been drawn to development of modems capable of transmitting or receiving data at a speed of 100 Mbps or higher and development of terminal interfaces capable of analyzing the performance of such modems. However, research on such modems and interfaces has not been satisfactory.

Moreover, with the development of wireless communication systems, public demand has steadily grown for establishing a development environment for research and development of new communication protocols and standards. Research has been conducted on ways to develop various modem applications using stabilized mobile platform apparatuses. However; mobile platform apparatuses capable of downloading modem software programs in a multi-band multi-carrier environment have not yet been developed.

### SUMMARY OF THE INVENTION

The present invention provides a mobile platform apparatus for a multiple antenna system which is capable of operating in a multi-band multi-carrier environment by providing a baseband/intermediate frequency (IF) board and a radio frequency (RF) board for respective corresponding bands and establishing 4 or 8 path channels for each of the bands and to which a MIMO technique and a beam-forming technique are applied.

The present invention also provides an apparatus for verifying a mobile platform apparatus for a multiple antenna system which can verify the mobile platform apparatus either in real time mode or in non-real time mode.

According to an aspect of the present invention, there is provided a mobile platform apparatus for a multiple antenna system which communicates with an external system. The mobile platform apparatus includes: a baseband unit which receives transmission data to be transmitted to the external system, modulates the transmission data, receives baseband reception data, and demodulates the baseband reception data; an intermediate frequency (IF) unit which receives the modulated transmission data from the baseband unit, converts the modulated transmission data into IF transmission data, receives IF reception data, converts the IF reception data into the baseband reception data, and transmits the baseband reception data to the baseband unit; and a radio frequency (RF) unit which receives the IF transmission data from the IF unit, converts the IF transmission data into RF transmission data, transmits the RF transmission data to the external system, receives RF reception data from the external system, converts the RF reception data into the IF reception data, and transmits the IF reception data to the IF unit. Each of the IF unit and the RF unit comprises a plurality of paths, and the transmission data and the reception data are transmitted via at least one of the paths.

According to another aspect of the present invention, there is provided an apparatus for verifying a mobile platform apparatus for a multiple antenna system. The apparatus includes: a mobile platform apparatus which communicates with an external system; and a terminal device which generates original verification data used for verifying the mobile platform apparatus, transmits the original verification data to the mobile platform apparatus, receives copy verification data from the mobile platform apparatus, compares the copy verification data with the original verification data, and determines whether the mobile platform apparatus operates normally based on the comparison results.

According to another aspect of the present invention, there is provided a mobile platform apparatus for a multiple antenna system which communicates with an external system. The mobile platform apparatus includes: a baseband/IF board which comprises: a baseband unit which receives transmission data to be transmitted to the external system, modulates the transmission data, receives baseband reception data, and demodulates the baseband reception data; and an IF unit which receives the modulated transmission data from the baseband unit, converts the modulated transmission data into IF transmission data, receives IF reception data, converts the IF reception data into the baseband reception data, and transmits the baseband reception data to the baseband unit; and an RF board which is installed in a different slot from the baseband/IF board, receives the IF transmission data from the IF unit, converts the IF transmission data into RF transmission data, transmits the RF transmission data to the external system, receives RF reception data from the external system, converts the RF reception data into the IF reception data, and transmits the IF reception data to the IF unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a mobile platform apparatus for a multiple antenna system according to an exemplary embodiment of the present invention and an apparatus for verifying the mobile platform apparatus according to an exemplary embodiment of the present invention;

FIG. 2 is a detailed block diagram illustrating the connection between an RF board and an antenna unit of the mobile platform apparatus of FIG. 1 according to an exemplary embodiment of the present invention;

FIG. 3 is a perspective view of a front portion of the mobile platform apparatus of FIG. 1 according to an exemplary embodiment of the present invention;

FIG. 4 is a perspective view of a rear portion of the mobile platform apparatus of FIG. 1 according to an exemplary embodiment of the present invention; and

FIG. 5 is a perspective view of a pan of the mobile platform apparatus of FIG. 3 or 4 according to an exemplary embodiment of the present invention.

### DETAILED DESCRIPTION OF THE INVENTION

The present invention will now be described more fully with reference to the accompanying drawings in which exemplary embodiments of the invention are shown.

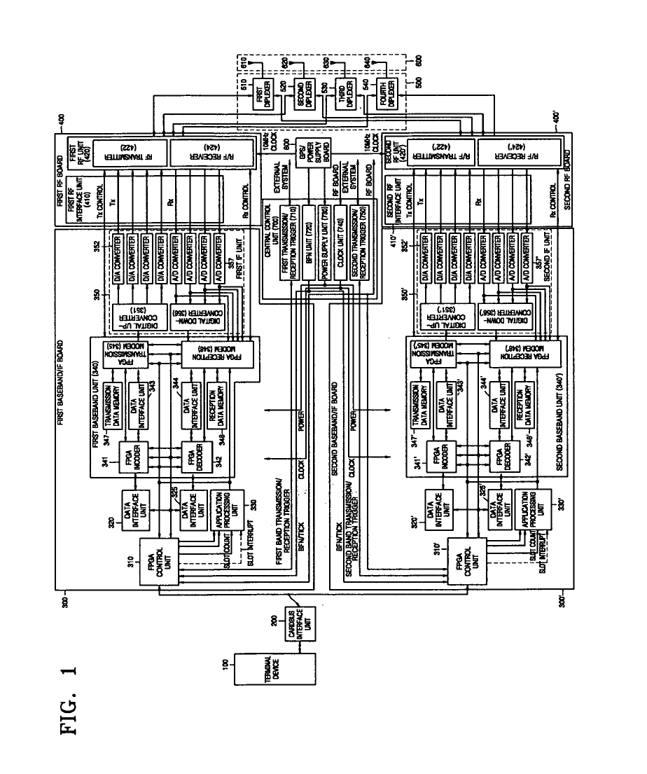

FIG. 1 is a block diagram of a mobile platform apparatus for a multiple antenna system according to an exemplary embodiment of the present invention and an apparatus for verifying the mobile platform apparatus according to an exemplary embodiment of the present invention. Referring to FIG. 1, the mobile platform apparatus includes a first baseband/intermediate frequency (IB) board 300, a second baseband/IF board 300′, a first radio frequency (RF) board 400, a second RF board 400′, a diplexer board 500, an antenna unit 600, a central control unit 700, and a global positioning system (GPS)/power supply board 800. The mobile platform apparatus may also include a terminal device 100 and a cardbus interface unit 200. Here, the terminal device 100 and the cardbus interface unit 200 constitute the apparatus for verifying the mobile platform apparatus according to an exemplary embodiment of the present invention, which can verify the functions of the mobile platform apparatus.

The first baseband/IF board 300 and the first RF board 400 transmit data to or receive data from an external system within a first band (e.g., 1.9 GHz), and the second baseband/IF board 300′ and the second RF board 400′ transmit data to or receive data from an external system within a second band (e.g., 2.7 GHz).

The first baseband/IF board 300 serves as a modem for transmitting or receiving data with a predetermined bandwidth (e.g., 20 MHz per path) and includes a field programmable gate array (FPGA) control unit 310, an application processing unit 330, a first baseband unit 340, and a first RF unit 350.

The FPGA control unit 310 interfaces with the cardbus interface unit 200 and controls the operation of the first baseband/IF board 300.

The application processing unit 330 enables various application programs to be executed in the first baseband/IF board 300 using an internal register.

The first baseband unit 340 includes an FPGA encoder 341, an FPGA transmission modem 345, a transmission data memory 347, an FPGA decoder 342, an FPGA reception modem 346, and a reception data memory 348. Data interface units 320, 325, 343, and 344 provide a data interface function by interfacing with units to which the data interface units 320, 325, 343, and 344 are connected. The first IF unit 350 includes a digital up-converter 351, a plurality of digital-to-analog (D/A) converters 352, a digital down-converter 356, and a plurality of analog-to-digital (A/D) converters 357.

The first RF board 400 includes a first RF interface unit 410 and a first RF unit 420. Here, the first RF unit 420 includes an RF transmitter 422 and an RF receiver 424.

The second baseband/IF board 300′ serves as a modem for transmitting or receiving data with a predetermined bandwidth (e.g., 20 MHz per path) and includes an FPGA control unit 310′, an application processing unit 330′, a second baseband unit 340′, and a second RF unit 350′.

The FPGA control unit 310′ interfaces with the cardbus interface unit 200 and controls the operation of the second baseband/IF board 300′.

The application processing unit 330′ enables various application programs to be executed in the second baseband/IF board 300′ using an internal register. The second baseband unit 340′ includes an FPGA encoder 341′, an FPGA transmission modem 345′, a transmission data memory 347′, an FPGA decoder 342′, an FPGA reception modem 346′, and a reception data memory 348′. Data interface units 320′, 325′, 343′, and 344′ provide a data interface function by interfacing with units to which the data interface units 320′, 325′, 343′, and 344′ are connected. The second IF unit 350′ includes a digital up-converter 351′, a plurality of D/A converters 352′, a digital down-converter 356′, and a plurality of A/D converters 357′.

The second RF board 400′ includes a second RF interface unit 410′ and a second RF unit 420′. Here, the second RF unit 420′ includes an RF transmitter 422′ and an RF receiver 424′.

The diplexer board 500 is connected to the first RF board 400 and the second board 400′ and to the antenna unit 600 and provides a time-division duplexing function for each of a plurality of bands at a front end of the antenna unit 600 by being switched from the first RF board 400 or the second RF board 400′ or vice versa.

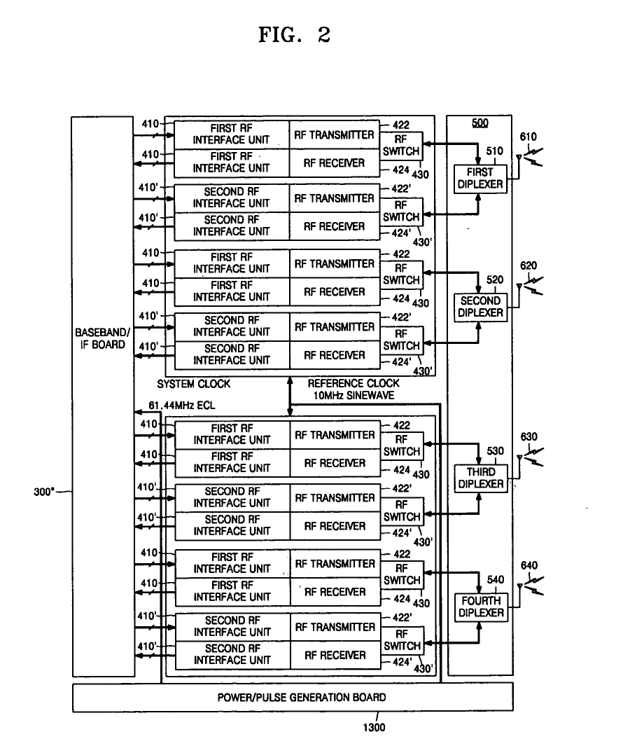

The diplexer board 500 includes a first diplexer 510, a second diplexer 520, a third diplexer 530, and a fourth diplexer 540. The relative orientation between the diplexer board 500 and the first RF board and the relative orientation among the antenna unit 600, the first RF board 400, and the second RF board 400′ will be described later in further detail with reference to FIG. 2.

The antenna unit 600 includes first through fourth antennas 610 through 640 which are connected to the first through fourth diplexers 510 through 540, respectively. The first through fourth antennas 610 through 640 are omni-directional antennas, and thus, the antenna unit 600 can accommodate both the first and second bands.

The first through fourth antennas 610 through 640 constituting the antenna unit 600 may be separate from one another. For example, a test environment for analyzing and enhancing the performance of the mobile platform apparatus may be established by spacing the first through fourth antennas 610 through 640 at regular or irregular intervals. In addition, the test environment may be established by designing the antenna unit 600 to be comprised of a plurality of polarization antennas instead of omni-directional antennas.

The central control unit 700 includes a first transmission/reception trigger 710, a beam forming network (BFN) unit 720, a power supply unit 730, a clock unit 740, and a second transmission/reception trigger 750.

The first transmission/reception trigger 710 triggers the FPGA control unit 310 to control the operation of the first baseband/IF board 300 in response to a control signal applied from an external system.

The BFN unit 720 receives a BFN signal from the GPS/power supply board 800, reproduces the BFN signal, and transmits the reproduction result to the FPGA control unit 310 and the FPGA control unit 310′ so that the FPGA control unit 310 and the FPGA control unit 310′ can operate in synchronization with an external system.

The power supply unit 730 provides a power applied from the GPS/power supply board 800 to the first baseband/IF board 300 and the second baseband/IF board 300′.

The clock unit 740 provides a system clock signal received from the first RF board 400 or the second RF board 400 to the first baseband/IF board 300 and the second baseband/IF board 300′.

The second transmission/reception trigger 750 triggers the FPGA control unit 310′ to control the operation of the second baseband/IF board 300′ in response to a control signal applied from an external system.

The GPS/power supply board 800 provides power and time synchronization information to the mobile platform apparatus. In detail, the GPS/power supply board 800 includes a power supply module for providing a power to the first and second baseband/IF boards 300 and 300′ and a GPS module for providing time synchronization information to the mobile platform apparatus. Therefore, the mobile platform apparatus can be used as a multiple antenna system without the need to develop a synchronization board for the mobile platform apparatus. Here, the BFN signal is transmitted to the first and second baseband/IF boards 300 and 300′ via the BFN unit 720 of the central control unit 700.

The clock unit 740 of the central control unit 700 provides a clock signal to the first and second RF boards 400 and 400′. The clock signal is a 2-port clock signal having a frequency of 10 MHz. The first and second RF boards 400 and 400′ synchronize themselves with each other using the 2-port clock signal and provide a synchronized clock signal (or a sine wave having a frequency of 122.88 MHz,) to the clock unit 740. Then, the clock unit 740 generates a system clock signal having a frequency of, e.g., 61.44 MHz, and transmits the system clock signal to the first and second baseband/IF boards 300 and 300′ such that the first and second baseband/IF boards 300 and 300′ can use the system clock signal on their own.

The terminal device 100 serves as both a signal processor and a graphic user interface.

The terminal device 100 may generate transmission data to be transmitted to an external system and transmit the transmission data via the mobile platform apparatus or may receive reception data transmitted by the external system via the mobile platform apparatus. This type of signal transmission/reception function provided by the terminal device 100 is referred to as a signal processing function. The terminal device 100 can also provide a signal monitoring function for the received signal. This signal monitoring function may facilitate development of a modem simulator for the mobile platform apparatus.

In addition, the terminal device 100 may serve as a graphic user interface. In detail, the terminal device 100 performs graphic processing in order to efficiently display various signal processing results to a user, and this type of function is referred to as a graphic user interface function.

The cardbus interface unit 200 can provide a data transmission speed of up to 264 MByte/sec (66 MHz×32 bits) using a 32-bit bus and thus can make the mobile platform apparatus compatible with a 4G wireless communication system.

The operations of the mobile platform apparatus according to an exemplary embodiment of the present invention and the apparatus for verifying the mobile platform apparatus according to an exemplary embodiment of the present invention will now be described in detail mainly focusing, for the convenience of description, on transmission/reception of data to/from an external system via the mobile platform apparatus according to an exemplary embodiment of the present invention and verification of the performance of the mobile platform apparatus according to an exemplary embodiment of the present invention.

The transmission of transmission data from the mobile platform apparatus according to an exemplary embodiment of the present invention and to an external system through the first baseband/IF board 300 and the first RF board 400 within the first band (e.g., 1.9 GHz) and the verification of the transmission operation will now be described in detail.

The transmission of transmission data from the mobile platform apparatus to an external system will now be described in detail.

The terminal device 100 generates transmission data to be transmitted to the external system via the mobile platform apparatus. The transmission data is transmitted together with a control signal for determining whether the transmission data is to be transmitted through the first band (e.g., 1.9 GHz) or the second band (e.g., 2.7 GHz) or through both of the first and second bands.

In addition, the terminal device 100 receives reception data transmitted by the external system via the cardbus interface unit 200 and outputs the reception data through a plurality of display devices.

Moreover, when transmitting transmission data, the terminal device 100 generates verification data used for verifying the performance of the mobile platform apparatus. The verification data comprises copy data and original data. The original data of the verification data is stored is stored in an internal storage device of the terminal device 100, and the copy data of the verification data is transmitted to the cardbus interface unit 200. Thereafter, when receiving reception data, the terminal device 100 receives the verification data from the cardbus interface unit 200, compares the verification data with the reception data, and determines whether the mobile platform apparatus operates normally based on the comparison results.

The cardbus interface unit 200 receives transmission data and a control signal from the terminal device 100 and transmits the transmission data to the first or second baseband/IF board 300 or 300′ with reference to the control signal. In detail, the cardbus interface unit 200 determines whether the transmission data is to be transmitted to the first or second baseband/IF board 300 or 300′ based on the control signal.

It is assumed that the transmission data is to be transmitted to the external system through the first barid (e.g., 1.9 GHz) via the first baseband/IF board 300 and the first RF board 400, the FPGA control unit 310 of the first baseband/IF board 300 receives the transmission data from the cardbus interface unit 200 and transmits the transmission data to the FPGA encoder 341 via the data interface unit 320.

The FPGA encoder 341 receives the transmission data, which is to be transmitted to the external system, from the FPGA control unit 310 via the data interface unit 320 and encodes the transmission data. The FPGA transmission modem 345 modulates the encoded transmission data received from the FPGA encoder 341 and transmits the modulated transmission data to the digital up-converter 351 of the first IF unit 350.

The digital up-converter 351 converts the modulated transmission data received from the FPGA transmission modem 345 into digital IF transmission data by performing digital filtering, digital frequency up-conversion, and I/Q combination operations. Thereafter, the digital up-converter 351 transmits the digital IF transmission data to the D/A converters 352.

The D/A converters 352 convert the digital IF transmission data received from the digital up-converter 351 into analog IF transmission data and transmit the analog IF transmission data to the first RF board 400. Here, the first RF unit 350 comprises 4 D/A converters (352) and can thus establish up to 4 channel paths. Therefore, the digital IF transmission data can be converted into the analog IF transmission data using the 4 channel paths.

The first RF interface unit 410 of the first RF board 400 receives the analog IF transmission data from the D/A converters 352 and transmits the analog IF transmission data to the RF transmitter 422 of the first RF unit 420 by interfacing with the analog IF transmission data.

The RF transmitter 422 of the first RF unit 420 up-converts the analog IF transmission data into RF transmission data and transmits the RF transmission data to the external system via the diplexer board 500 and the antenna unit 600.

The transmission of reception data from an external system to the mobile platform apparatus according to an exemplary embodiment of the present invention will now be described in detail.

The RF receiver 424 of the first RF board 400 receives reception data transmitted by the external system via the antenna unit 600 and the diplexer board 500. The reception data is RF reception data within an RF band which contains data to be transmitted to the mobile platform apparatus. The RF receiver 424 down-converts the reception data into IF reception data and transmits the IF reception data to the first RF interface unit 410 of the first RF board 400. The first RF interface unit 410 receives the IF reception data from the RF receiver 424 and transmits the IF reception data to the A/D converters 357 of the first IF unit 350 by interfacing with the IF reception data.

The A/D converters 357 receive the IF reception data from the first RF interface unit 410, converts the IF reception data into digital IF reception data, and transmits the digital IF reception data to the digital down-converter 356. Since the first RF unit 350 includes 4 A/D converters (357), it can establish up to 4 channel paths. Therefore, the IF reception data can be converted into the digital IF reception data using the 4 channel paths.

The digital down-converter 356 obtains baseband reception data by performing digital filtering, digital down-conversion, and I/Q separation operations on the digital IF reception data and transmits the baseband reception data to the FPGA reception modem 346 of the first baseband unit 340.

The FPGA reception modem 346 receives the baseband reception data from the digital down-converter 356, demodulates the baseband reception data, and transmits the demodulated baseband reception data to the FPGA decoder 342.

The FPGA decoder 342 decodes the demodulated baseband reception data received from the FPGA reception modem 346 and transmits the decoded baseband reception data to the FPGA control unit 310 via the data interface unit 325.

The FPGA control unit 310 receives the decoded baseband reception data from the FPGA decoder 342 and transmits the decoded baseband reception data to the cardbus interface unit 200.

The cardbus interface unit 200 receives the decoded baseband reception data from the FPGA control unit 310 and transmits the decoded baseband reception data to the terminal device 100.

The terminal device 100 receives the decoded baseband reception data from the cardbus interface unit 200 and may display the decoded baseband reception data. In this manner, the terminal device 100 receives the reception data transmitted by the external system.

The verification of the performance of the mobile platform apparatus according to an exemplary embodiment of the present invention by the apparatus for verifying a mobile platform apparatus for a multiple antenna system according to an exemplary embodiment of the present invention will now be described in detail. In detail, the verification of the performance of the mobile platform apparatus mainly focuses on determining whether the first baseband unit 340, the first IF unit 350, and the first RF board 400 of the first baseband/IF board 300 operate normally.

The determining of whether the first baseband unit 340 of the first baseband/IF board 300 operates normally will now be described in detail.

The terminal device 100 generates verification data used for verifying the performance of the first baseband/IF board 300, particularly, the first baseband unit 340. The verification data comprises original data and copy data. The original data of the verification data is stored in an internal storage device of the terminal device 100, and the copy data of the verification data is transmitted to the cardbus interface unit 200. The verification data may be transmitted together with a control signal used for determining whether the verification data is to be transmitted through the first band (e.g., 1.9 GHz) or the second band (e.g., 2.7 GHz) or through both of the first and second bands. The terminal device 100 downloads various modem software programs and can thus verify the performance of the mobile platform apparatus in real time mode or in non-real time mode. Therefore, it is possible to readily respond to new communication protocols and standards regarding wireless communication systems.

The cardbus interface unit 200 receives the verification data and the control signal from the terminal device 100 and transmits the verification data to the first or second baseband/IF board 300 or 300′ with reference to the control signal. In detail, the cardbus interface unit 200 determines whether the verification data is to be transmitted to the first or second baseband/IF board 300 or 300′ with reference to the control signal.

It is assumed that the verification data is to be transmitted to the external system through the first band (e.g., 1.9 GHz) via the first baseband/IF board 300 and the first RF board 400.

The FPGA control unit 310 of the first baseband/IF board 300 receives the verification data from the cardbus interface unit 200 and transmits the verification data to the FPGA encoder 341 via the data interface unit 320.

The FPGA encoder 341 receives the verification data from the FPGA control unit 310 and encodes the verification data.

The FPGA transmission modem 345 receives the encoded verification data from the FPGA encoder 341 via the data interface unit 343 and modulates the encoded verification data. The FPGA transmission modem 345 transmits the modulated verification data to the FPGA reception modem 346.

The FPGA reception modem 346 receives the modulated verification data from the FPGA transmission modem 345, demodulates the modulated verification data, and transmits the demodulated verification data to the FPGA decoder 342 via the data interface unit 344. The FPGA decoder 342 decodes the demodulated verification data received from the FPGA reception modem 346 and transmits the decoded verification data to the FPGA control unit 310 via the data interface unit 325.

The FPGA control unit 310 receives the decoded verification data from the FPGA decoder 342 and transmits the decoded verification data to the cardbus interface unit 200.

The cardbus interface unit 200 transmits the decoded verification data received from the FPGA control unit 310 of the first baseband/IF board 300 to the terminal device 100.

The terminal device 100 receives the verification data from the cardbus interface unit 200, compares the verification data with the original data stored in advance in the internal storage device thereof, and determines whether the first baseband unit 340 operates normally based on the comparison results. In detail, if the verification data is identical to the original data stored in advance in the internal storage device of the terminal device 100, the terminal device 100 determines that the first baseband unit 340 operates normally.

The determining of whether the second IF unit 350 of the first baseband/IF board 300 operates normally will now be described in detail, focusing mainly on differences with the determining of whether the first baseband unit 340 operates normally.

The FPGA transmission modem 345 receives encoded verification data from the FPGA encoder 341 via the data interface unit 343, modulates the encoded verification data, and transmits the modulated verification data to the digital up-converter 351 of the first IF unit 350.

The digital up-converter 351 converts the modulated verification data received from the FPGA transmission modem 345 into IF verification data by performing digital filtering, digital frequency up-conversion, and I/Q combination operations. Thereafter, the digital up-converter 351 transmits the IF verification data to the D/A converters 352 of the first IF unit 350.

The D/A converters 352 convert the IF verification data received from the digital up-converter 351 into analog IF verification data. The D/A converters 352 transmit the analog IF verification data to the A/D converters 357. Since the first IF unit 350 includes 4 D/A converters (352), it can establish up to 4 channel paths. Therefore, the IF verification data can be converted into the analog IF verification data using the 4 channel paths.

The A/D converters 357 convert the analog IF verification data received from the D/A converters 352 into digital IF verification data and transmit the digital IF verification data to the digital down-converter 356. Here, since the first IF unit 350 includes 4 A/D converters (357), it can establish up to 4 channel paths. Thus, the analog IF verification data can be converted into the digital IF verification data using the 4 channel paths.

The digital down-converter 356 converts the digital IF verification data received from the A/D converters 357 into baseband verification data by performing digital filtering, digital down-conversion, and I/Q separation operations. Thereafter, the digital down-converter 356 transmits the baseband verification data to the FPGA reception modem 346 of the first baseband unit 340.

The FPGA reception modem 346 demodulates the baseband verification data received from the digital down-converter 356 and transmits the demodulated verification data to the FPGA decoder 342 via the data interface unit 344.

The FPGA decoder 342 decodes the demodulated verification data received from the FPGA reception modem 346 and transmits the decoded verification data to the FPGA control unit 310 via the data interface unit 325.

The FPGA control unit 310 receives the decoded verification data from the FPGA decoder 342 and transmits the decoded verification data to the cardbus interface unit 200.

The cardbus interface unit 200 receives the decoded verification data from the FPGA control unit 310 and transmits the decoded verification data to the terminal device 100.

The terminal device 100 receives the decoded verification data from the cardbus interface unit 200, compares the decoded verification data with original data stored in advance in an internal storage device of the terminal device 100, and determines whether the first IF unit 350 operates normally based on the comparison results. In detail, if the decoded verification data received from the cardbus interface unit 200 is identical to the original data stored in advance in the internal storage device of the terminal device 100, the terminal device 100 determines that the first IF unit 350 operates normally.

The determining of whether the first RF board 400 operates normally will now be described in detail mainly focusing on differences with the determining of whether the first baseband unit 340 or the first IF unit 350 operates normally.

The D/A converters 352 receive IF verification data from the digital up-converter 351, converts the IF verification data into analog IF verification data, and transmits the analog IF verification data to the first RF board 400. Here, the first IF unit 350 includes 4 D/A converters (352), it can establish up to 4 channel paths. Therefore, the IF verification data received from the digital up-converter 351 can be converted into the analog IF verification data using the 4 channel paths.

The first RF interface unit 410 of the first RF board 400 receives the analog IF verification data from the D/A converters 352 and transmits the analog IF verification data to the RF transmitter 422 of the first RF unit 420 by interfacing with the analog IF verification data.

The RF transmitter 422 up-converts the analog IF verification data into RF verification data and transmits the RF verification data to the RF receiver 424.

The RF receiver 424 of the first RF board 400 receives the RF verification data from the RF transmitter 424, down-converts the RF verification data into IF verification data, and transmits the IF verification data to the first RF interface unit 410 of the first RF board 400.

The first RF interface unit 410 receives the IF verification data from the RF receiver 424 and transmits the IF verification data to the A/D converters of the first IF unit 350 by interfacing with the IF verification data.

The A/D converters 357 receives the IF verification data from the first RF interface unit 410, converts the IF verification data into digital IF verification data, and transmits the digital verification data to the digital down-converter 356. Here, since the first IF unit 350 includes 4 A/D converters (357), it can establish up to 4 channel paths. Therefore, the IF verification data received from the first RF interface unit 410 can be converted into the digital IF verification data using the 4 channel paths.

The digital down-converter 356 receives the digital IF verification data from the A/D converters 357 and down-converts the digital IF verification data into digital baseband verification data by performing digital filtering, digital down-conversion, and I/Q separation operations. Thereafter, the digital down-converter 356 transmits the digital baseband verification data to the FPGA reception modem 346 of the first baseband unit 340.

The FPGA reception modem 346 receives the digital baseband verification data from the digital down-converter 356, demodulates the digital baseband verification data, and transmits the demodulated verification data to the FPGA decoder 342 via the data interface unit 344.

The FPGA decoder 342 decodes the demodulated verification data received from the FPGA reception modem 346 and transmits the decoded verification data to the FPGA control unit 310 via the data interface unit 325.

The FPGA control unit 310 receives the decoded verification data from the FPGA decoder 342 and transmits the decoded verification data to the cardbus interface unit 200.

The cardbus interface unit 200 receives the decoded verification data from the FPGA control unit 310 of the first baseband/IF board 300 and transmits the decoded verification data to the terminal device 100.

The terminal device 100 receives the decoded verification data from the cardbus interface unit 200, compares the decoded verification data with original data stored in advance in an internal storage device thereof, and determines whether the first RF board 400 operates normally based on the comparison results. In detail, if the decoded verification data received from the cardbus interface unit 200 is identical to the original data stored in advance in the internal storage device of the terminal device 100, the terminal device 100 determines that the first RF board 400 operates normally.

FIG. 2 is a diagram illustrating the relative orientation among a baseband/IF board, an RF board, and a diplexer board 500 of the mobile platform apparatus of FIG. 1 according to an exemplary embodiment of the present invention. Referring to FIG. 2, the diplexer board 500 includes a first diplexer 510, a second diplexer 520, a third diplexer 530, and a fourth diplexer 540. The first diplexer 510 is connected to an RF transmitter 422 and an RF receiver 424 which form a path in the first RF unit 420 and is also connected to an RF transmitter 422′ and an RF receiver 424′ which form a path in the second RF unit 420′.

The first diplexer 510 controls the operations of the RF transmitter 422 and the RF receiver 424 by turning on or off the RF transmitter 422 and the RF receiver 424 using an RF switch 430.

In addition, the first diplexer 510 controls the operations of the RF transmitter 422′ and the RF receiver 424′ by turning on or off the RF transmitter 422′ and the RF receiver 424′ using an RF switch 430′.

Therefore, a first antenna 610 which is connected to the first diplexer 510 can be used in the first band (e.g., 1.9 GHz) and the second band (e.g., 2.7 GHz).

The operations of second, third, and fourth diplexers 520, 530, and 540 are the same as the operation of the first diplexer 510, and thus, their detailed descriptions will be skipped.

The baseband/IF board 300″ is the combination of the first and second baseband/IF boards 300 and 300′ of FIG. 1. A power/pulse generation board 1300 provides a clock pulse (e.g., a sinewave having a frequency of 122.88 MHz) to the baseband/IF board 300″, so the baseband/IF board 300″ can generate a system clock signal having a frequency of, for example, 61.44 MHz, based on the clock pulse. In addition, the power/pulse generation board 1300 provides a reference clock signal (e.g., a sine wave having a frequency of 10 MHz) to the first or second RF board 400 or 400′.

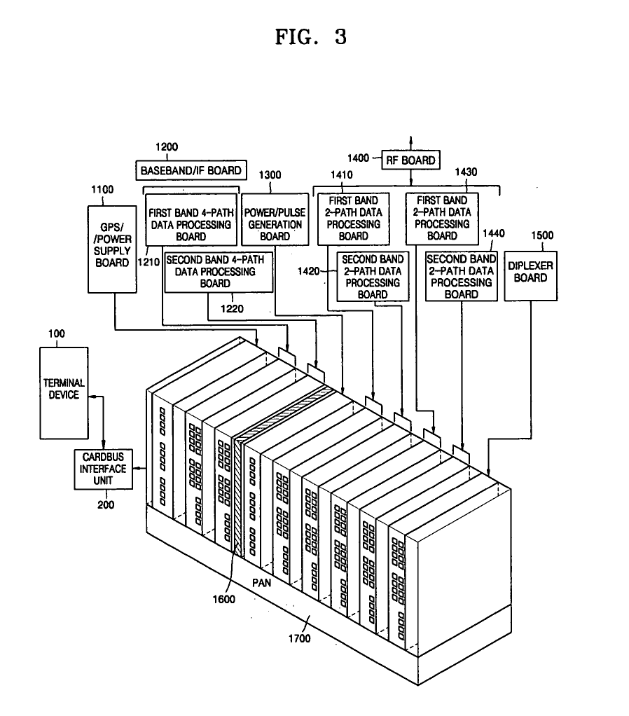

FIG. 3 is a perspective view of a front portion of the mobile platform apparatus of FIG. 1 according to an exemplary embodiment of the present invention. Referring to FIG. 3, the front portion of the mobile platform apparatus includes a GPS/power supply board 1100, a baseband/IF board 1200, a power/pulse generation board 1300, an RF board 1400, a diplexer board 1500, an insulation plate 1600, and a pan 1700.

The mobile platform apparatus may also include the terminal device 100 and the cardbus interface unit 200 of FIG. 1, in which case, the terminal device 100 and the cardbus interface unit 200 constitute an apparatus for verifying the performance of the mobile platform apparatus.

The GPS/power supply board 1100 provides power and time synchronization information to the mobile platform apparatus. In detail, the GPS/power supply board 1100 includes a power supply module or a power supply board which provides a power to the baseband/IF board 1200 and the power/pulse generation board 1300 and a GPS module or a GPS board which provides time synchronization information to the mobile platform apparatus and can thus reduce the time required to implement the mobile platform apparatus by as much as the time required to develop a synchronization module for the mobile platform apparatus.

The baseband/IF board 1200 can process transmission/reception data and verification data through each of the first and second bands (e.g., 1.9 GHz and 2.7 GHz bands). The baseband/IF board 1200 includes an FPGA control unit (not shown) which can control the operation of the baseband/IF board 1200 and an application processor which can enable various application programs to be executed in the baseband/IF board 1200.

The baseband/IF board 1200 can realize a multi-band multi-carrier mobile platform apparatus capable of satisfying the requirements of 4G wireless systems by providing high data transmission quality and a high data transmission speed of 100 Mbps or higher.

The baseband/IF board 1200 is illustrated in FIG. 3 as comprising a first band 4-path data processing board 1210 which can deal with the first band (e.g., 1.9 GHz) and a second band 4-path data processing board 1220 which can deal with the second band (e.g., 2.7 GHz). However, the baseband/IF board 1200 may be comprised of a plurality of data processing boards which can establish more than or less than 4 channel paths.

The power/pulse generation board 1300 generates a power and a clock signal for the RF board 1400. The baseband/IF board 1200 and the power/pulse generation board 1300 are insulated from each other by the insulation plate 1600.

The RF board 1400 comprises 2 data processing boards for each of the first and second bands, and each of the data processing boards can deal with 2 paths. In other words, the RF board 1400 comprises 4 data processing boards and can thus operate in a multi-band multi-carrier system. In detail, the RF board 1400 includes a first band 2-path data processing board 1410, a second band 2-path data processing board 1420, a first band 2-path data processing board 1430, and a second band 2-path data processing board 1440. The RF board 1400 may be comprised of a plurality of data processing boards which can establish more than or less than 4 channel paths.

The diplexer board 1500 enables the mobile platform apparatus to be driven in a multi-band multi-carrier system. The diplexer board 1500 is controlled by a transmission switching signal and a reception switching signal for each of the first and second bands for RF transmission data transmitted by the RF board 1400. The operation of the diplexer board 1500 has already been described with reference to FIG. 2, and thus, its detailed description will be skipped.

The insulation plate 1600 physically separates the baseband/IF board 1200 from the RF board 1400. Here, the insulation plate 1600 blocks noise that can be generated from the baseband/IF board 1200 and can thus enable the RF board 1400 to operate efficiently.

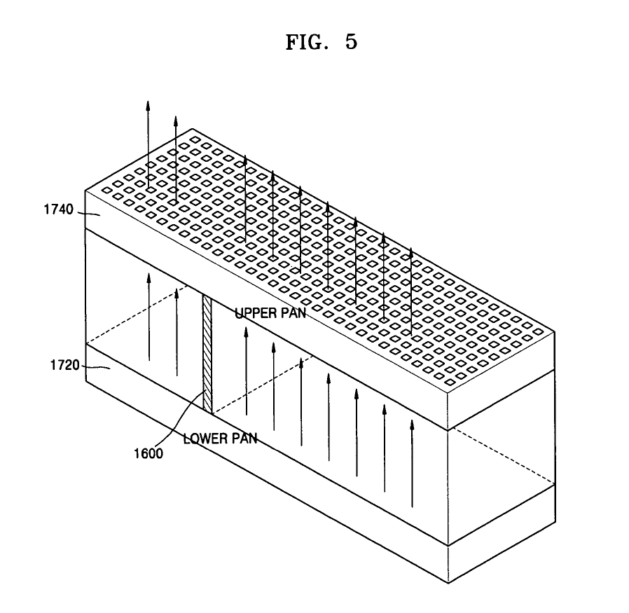

The pan 1700 prevents the convection of warm air generated inside the mobile platform apparatus, thereby preventing the mobile platform apparatus from malfunctioning due to heat. The pan 1700 is illustrated in FIG. 3 as being installed only at the bottom of the mobile platform apparatus. However, the pan 1700 may also be installed on the top of the mobile platform apparatus. The structure of the pan 1700 will be described in detail with reference to FIG. 5.

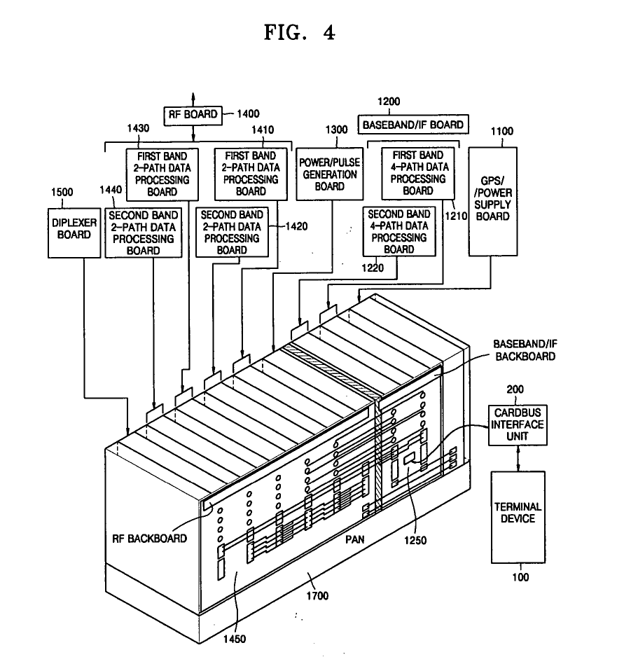

FIG. 4 is a perspective view of a rear portion of the mobile platform apparatus of FIG. 1 according to an exemplary embodiment of the present invention. Referring to FIG. 4, the rear portion of the mobile platform apparatus includes a baseband/IF backboard 1250, which corresponds to the baseband/IF board 1200, and an RF backboard 1450, which corresponds to the RF board 1400.

The front portion of the mobile platform apparatus is hermetically sealed by a stiffener of a front panel, and the rear portion of the mobile platform apparatus is hermetically sealed by the baseband/IF backboard 1250 and the RF backboard 1450, thereby maximizing the cooling effect of the pan 1700 on the mobile platform apparatus.

FIG. 5 is a perspective view of the pan 1700 of FIG. 3 or 4 according to an exemplary embodiment of the present invention. Referring to FIG. 5, the pan 1700 has a 2-level structure consisting of a lower pan 1720 and an upper pan 1740. Therefore, the pan 1700 can effectively prevent the convection of warm air inside the mobile platform apparatus according to an exemplary embodiment of the present invention and can thus prevent the mobile platform apparatus from malfunctioning due to heat.

An insulation plate 1600 physically separates the mobile platform apparatus into 2 parts, i.e., the baseband/IF board 1200 and the RF board 1400 of FIG. 3 or 4.

The mobile platform for a multiple antenna system apparatus according to the present invention and the apparatus for verifying a mobile platform apparatus for a multiple antenna system according to the present invention provide the following advantages.

In the present invention, a baseband/IF board and an RF board are provided, a plurality of paths, e.g., 4 or 8 paths, via which transmission data and reception data can be transmitted, are established. Therefore, it is possible to realize a mobile platform apparatus for a multiple antenna system using a MIMO technique and a beam-forming technique and to realize an apparatus for verifying the mobile platform apparatus.

In the present invention, a plurality of baseband/IF boards and a plurality of RF boards are provided, thereby handling a plurality of bands. Therefore, it is possible to provide a mobile platform apparatus for a multiple antenna system which can operate in a multi-band multi-carrier environment. For example, it is possible to provide a mobile platform apparatus for a multiple antenna system which processes 2 bands and provides 4 paths for each of the 2 bands (20 Msps per path), in which case, the mobile platform apparatus can provide a 160 Msps band using the 2 bands (80 Msps per band). Therefore, the present invention can be applied to a 4G wireless communication system requiring a data transmission speed of 100 Mbps or higher.

In the present invention, a cardbus interface unit which can support a data transmission speed of, for example, up to 264 Mbytes/s (66 MHz×32 bits), using, for example, a 32-bit bus, is provided. Therefore, the present invention can be applied to a 4G wireless communication system.

In the present invention, it is possible to verify the performance of a mobile platform apparatus for a multiple antenna system either in real time mode or in non-real time mode by downloading various modem software programs in a multi-band multi-carrier environment. Therefore, it is possible to quickly respond to new communication protocols and standards regarding wireless communication systems and to reduce the research and development period of a mobile platform apparatus for a multiple antenna system.

In the present invention, a pan haying a 2-level structure of upper and lower pans is installed at the top and bottom of a mobile platform apparatus. Thus, it is possible to effectively prevent the convection of warm air inside the mobile platform apparatus. Therefore, it is possible to prevent the mobile platform apparatus and an apparatus for verifying the mobile platform apparatus from malfunctioning due to heat.

In the present invention, a baseband/IF board and an RF board are physically separated from each other by an insulation plate. Therefore, it is possible to block noise generated from the baseband/IF board and thus realize a highly effective mobile platform apparatus for a multiple antenna system and a highly effective apparatus for verifying a mobile platform apparatus for a multiple antenna system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A mobile platform apparatus for a multiple antenna system which communicates with an external system, the mobile platform apparatus comprising:
a baseband unit which receives transmission data to be transmitted to the external system, modulates the transmission data, receives baseband reception data, and demodulates the baseband reception data;
an intermediate frequency (IF) unit which receives the modulated transmission data from the baseband unit, converts the modulated transmission data into IF transmission data, receives IF reception data, converts the IF reception data into the baseband reception data, and transmits the baseband reception data to the baseband unit; and
a radio frequency (RF) unit which receives the IF transmission data from the IF unit, converts the IF transmission data into RF transmission data, transmits the RF transmission data to the external system, receives RF reception data from the external system, converts the RF reception data into the IF reception data, and transmits the IF reception data to the IF unit,
wherein each of the IF unit and the RF unit comprises a plurality of paths, and the transmission data and the reception data are transmitted via at least one of the paths.

2. The mobile platform apparatus of claim 1 further comprising a terminal device which transmits the transmission data to the baseband unit and receives decoded reception data from the baseband unit.

3. The mobile platform apparatus of claim 2 further comprising an interface unit which is located between the terminal device and the baseband unit and interfaces with the transmission data and the reception data.

4. The mobile platform apparatus of claim 3, wherein the interface unit uses a bus using more than a predefined number of bits required to perform fourth generation (4G) wireless communication.

5. The mobile platform apparatus of claim 1 further comprising a FPGA control unit which controls operations of the baseband unit, the IF unit, and the RF unit.

6. The mobile platform apparatus of claim 1, wherein the baseband unit comprises:
an FPGA encoder which encodes the transmission data;
an FPGA transmission modem which modulates the encoded transmission data;
an FPGA reception modem which receives the baseband reception data from the IF unit and demodulates the baseband reception data; and
an FPGA decoder which decodes the demodulated baseband reception data.

7. The mobile platform apparatus of claim 1, wherein the IF unit comprises:
a digital up-converter which receives the modulated transmission data from the baseband unit and converts the modulated transmission data into IF transmission data;
a digital-to-analog (D/A) converter which converts the IF transmission data into analog IF transmission data;
an analog-to-digital (A/D) converter which receives the IF reception data from the RF unit and converts the IF reception data into digital IF reception data; and
a digital down-converter which converts the digital IF reception data into baseband reception data and transmits the baseband reception data to the baseband unit.

8. The mobile platform apparatus of claim 1 comprising a plurality of baseband units, a plurality of IF units, and a plurality of RF units, wherein the transmission data and the reception data are transmitted via a plurality of bands.

9. The mobile platform apparatus of claim 1, wherein the IF unit and the RF unit constitute one of the bands and each comprise a plurality of paths, and the transmission and the reception data are transmitted via at least one of the paths of each of the IF unit and the RF unit.

10. The mobile platform apparatus of claim 9 further comprising a diplexer unit which comprises a number of diplexers corresponding to the number of paths, each of the diplexers being connected to one of a plurality of paths of a first RF unit belonging to a first band and to one of a plurality of paths of a second RF unit belonging to a second band.

11. The mobile platform apparatus of claim 10 further comprising an antenna unit which comprises a number of antennas corresponding to the number of diplexers included in the diplexer unit,
wherein the antennas are connected to the respective diplexers, transmit the RF transmission data to the external system, and receive the RF reception data from the external unit.

12. The mobile platform apparatus of claim 1, wherein each of the paths has a predefined bandwidth required to perform 4G wireless communication.

13. An apparatus for verifying a mobile platform apparatus for a multiple antenna system, the apparatus comprising:
a mobile platform apparatus which communicates with an external system; and
a terminal device which generates original verification data used for verifying the mobile platform apparatus, transmits the original verification data to the mobile platform apparatus, receives copy verification data from the mobile platform apparatus, compares the copy verification data with the original verification data, and determines whether the mobile platform apparatus operates normally based on the comparison results.

14. The apparatus of claim 13 further comprising an interface unit which is located between the terminal device and the mobile platform apparatus and interfaces with the original verification data and the copy verification data.

15. The apparatus of claim 13, wherein the mobile platform apparatus comprises:
a baseband unit which receives the original verification data, modulates the original verification data, receives copy baseband verification data, and demodulates and decodes the copy baseband verification data, the copy baseband verification data being used for verifying the baseband unit;
an IF unit which receives the modulated original verification data from the baseband unit, converts the modulated original verification data into original IF verification data, receives copy IF verification data, converts the copy IF verification data into baseband reception data, and transmits the baseband reception data to the baseband unit, the original and copy IF verification data being used for verifying the IF unit; and
an RF unit which receives the original IF verification data from the IF unit, converts the original IF verification data into original RF verification data, receives copy RF verification data, converts the copy RF verification data into copy IF verification data, and transmits the copy IF verification data to the IF unit, the original and copy RF verification data being used for verifying the RF unit,
wherein each of the IF unit and the RF unit comprises a plurality of paths, and the transmission data and the reception data are transmitted via at least one of the paths.

16. The apparatus of claim 15, wherein the baseband unit comprises:
an FPGA encoder which encodes the original verification data;
an FPGA transmission modem which modulates the encoded original verification data;
an FPGA reception modem which receives the copy baseband verification data and demodulates the copy baseband verification data; and
an FPGA decoder which decodes the demodulated copy baseband verification data.

17. The apparatus of claim 16, wherein, when verifying the baseband unit of the mobile platform apparatus, the FPGA transmission modem and the FPGA reception modem are connected to each other without the need to operate in conjunction with the IF unit so that the modulated original verification data obtained by the FPGA transmission modem can be transmitted to the FPGA reception modem as the copy baseband verification data.

18. The apparatus of claim 15, wherein the IF unit comprises:
a digital up-converter which receives the modulated original verification data from the baseband unit and converts the modulated original verification data into original IF verification data;
a D/A converter which converts the original IF verification data into analog original IF verification data;
an A/D converter which receives the copy IF verification data and converts the copy IF verification data into digital copy IF verification data; and
a digital down-converter which converts the digital copy IF verification data into copy baseband verification data and transmits the copy baseband verification data to the baseband unit.

19. The apparatus of claim 18, wherein, when verifying the IF unit of the mobile platform apparatus, the D/A converters and the A/D converters are connected to one another without the need to operate in conjunction with the RF unit so that the analog original IF verification data obtained by the D/A converters can be transmitted to the A/D converters as the copy IF verification data.

20. The apparatus of claim 15, wherein the RF unit comprises:
an RF transmitter which receives the original IF verification data from the IF unit and converts the original IF verification data into original RF verification data; and
an RF receiver which receives the copy RF verification data, converts the copy RF verification data into copy IF verification data, and transmits the copy IF verification data to the IF unit.

21. The apparatus of claim 20, wherein, when verifying the RF unit of the mobile platform apparatus, the RF transmitter and the RF receiver are connected to each other so that the original RF verification data obtained by the RF transmitter can be transmitted to the RF receiver as the copy IF verification data.

22. The apparatus of claim 20, wherein the RF unit further comprises an RF interface which is located between the IF unit and the RF unit and interfaces with the original IF verification data and the copy RF verification data.

23. The apparatus of claim 15, wherein the mobile platform apparatus comprises a plurality of baseband units, a plurality of IF units, and a plurality of RF units, and the original verification data and the copy verification data are transmitted via a plurality of bands.

24. The apparatus of claim 23, wherein the IF unit and RF unit constitute one of the bands and each comprise a plurality of paths, and the original verification data and the copy verification data are transmitted via at least one of the paths.

25. The apparatus of claim 15, wherein each of the paths has a predefined bandwidth required to perform 4G wireless communication.

26. A mobile platform apparatus for a multiple antenna system which communicates with an external system, the mobile platform apparatus comprising:
a baseband/IF board which comprises: a baseband unit which receives transmission data to be transmitted to the external system, modulates the transmission data, receives baseband reception data, and demodulates the baseband reception data; and an IF unit which receives the modulated transmission data from the baseband unit, converts the modulated transmission data into IF transmission data, receives IF reception data, converts the IF reception data into the baseband reception data, and transmits the baseband reception data to the baseband unit; and
an RF board which is installed in a different slot from the baseband/IF board, receives the IF transmission data from the IF unit, converts the IF transmission data into RF transmission data, transmits the RF transmission data to the external system, receives RF reception data from the external system, converts the RF reception data into the IF reception data, and transmits the IF reception data to the IF unit.

27. The mobile platform apparatus of claim 26 further comprising an insulation plate which isolates the baseband/IF board and the RF board from each other.

28. The mobile platform apparatus of claim 26 further comprising a plurality of pans which dissipate heat generated inside the mobile platform apparatus and are installed at the top and bottom of the mobile platform apparatus.

29. The mobile platform apparatus of claim 28 being hermetically sealed by the pans, a front panel, and a backboard.

30. The mobile platform apparatus of claim 26 further comprising a global positioning system (GPS) board which is installed in a different slot from the baseband/IF board and the RF board and provides time synchronization information to the baseband/IF board and the RF board.

31. The mobile platform apparatus of claim 26, wherein the baseband/IF board comprises:
a first baseband/IF board which processes the transmission data and the reception data using a first band; and
a second baseband/IF board which processes the transmission data and the reception data using a second band, and
the RF board comprises:
2 first band RF boards which process the transmission data and the reception data using the first band; and
2 second band RF boards which process the transmission data and the reception data using the second band.

32. The mobile platform apparatus of claim 31, wherein the first and second baseband/IF boards each comprise 4 paths, and the first band and second band RF boards each comprise 2 paths.

33. The mobile platform apparatus of claim 32, wherein each of the paths has a predefined bandwidth required to perform 4G wireless communication.

34. The mobile platform apparatus of claim 26 further comprising a diplexer board which is installed in a different slot from the baseband/IF board and the RF board, receives the RF transmission data from the RF board, transmits the RF transmission data to the external system via an antenna unit, receives the RF reception data from the external system via the antenna unit, and transmits the RF reception data to the RF board.
